(19) United States
(12) Patent Application Publication
(10) Pub. No.: US 2009/0229933 A1
(43) Pub. Date: Sep. 17, 2009

(54) Disc Brake Pad

(75) Inventor: Nui Wang, Victoria (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: PBR Australia Pty Ltd., East Bentleigh (AU)

(21) Appl. No.: 11/886,357

(22) PCT Filed: Mar. 16, 2006
(86) PCT No.: PCT/AU2006/000353

§ 371 Date: Jul. 8, 2008

(30) Foreign Application Priority Data
Mar. 16, 2005 (AU) 2005901291

(51) Int. Cl. F16D 65/092; F16D 55/10

(52) U.S. Cl. 188/250 H; 188/72.9

(57) ABSTRACT

A disc brake pad (210) is disclosed, including a front side (216) for engaging a disc brake rotor and a rear side (218) for engagement by respective service (233) and park brake (232) actuators. The rear side of the pad (210) includes a recess arrangement (220) for receiving a disc brake pad engaging portion (225) of the park brake actuator (232).

### CROSS-REFERENCE TO RELATED APPLICATIONS

The present application is a national phase entry under 35 U.S.C. § 371 of International Application No. PCT/AU2006/000353 filed Mar. 16, 2006, which claims priority from Australian Provisional Patent Application No. 2005901291 filed on 16 Mar. 2005, the disclosures of which are incorporated herein by reference.

### FIELD OF THE INVENTION

The present invention relates to a vehicle disc brake pad and a disc brake caliper incorporating such a pad. The present invention will be described generally in relation to calipers having both service and park braking capabilities although it is to be appreciated, that the invention may have broader application to other forms of vehicle brakes.

### BACKGROUND OF THE INVENTION

While existing disc brake calipers having both service and park braking capabilities can operate adequately in both the service and park braking modes, refinements to improve their operation are desirable. Refinements to the parking brake actuator of such calipers to improve the operation and/or performance thereof are highly desirable.

### SUMMARY OF THE INVENTION

In accordance with one aspect of the present invention, there is provided a disc brake pad, including a front side for engaging a disc brake rotor and a rear side for engagement by respective service and park brake actuators, the rear side of the pad including a recess for receiving a disc brake pad engaging portion of the park brake actuator.

The present invention also provides a disc brake caliper including a service brake actuator, a parking brake actuator and disc brake pads which in use are supported by the caliper on either side of a disc brake rotor, each of the disc brake pads including a front side for engaging a side of the disc brake rotor, and a rear side, each of the service brake actuator and the park brake actuator being arranged for engagement with the rear side of a first of the disc brake pads and wherein the park brake actuator includes a disc brake pad engaging portion and the first pad includes a recess for receiving the disc brake pad engaging portion at least when the park brake actuator is operating to shift the first pad into engagement with the disc brake rotor.

The recess provided in the rear side of the brake pad may be of any form suitable for receiving the disc brake pad engaging portion of the park brake actuator. In one preferred form, the recess is of a generally complementary size and shape to the park brake actuator's pad engaging portion. Alternatively, the recess may be of a size and shape to receive the park brake actuator's pad engaging portion within, for example, manufacturing, assembly and operating tolerances of the various caliper components.

The recess may extend inwardly from a planar rear surface of the brake pad. Alternatively, the recess may be generally crater-like (or crateriform), in which the recess extends inwardly from a rim raised from a planar rear surface of the brake pad.

Preferably, the depth of the recess is at least sufficient to receive the pad engaging portion of the park brake actuator during operation of the parking brake.

The depth of the recess may also be sufficient to accommodate at least a portion of the pad engaging portion of the park brake actuator when the park brake actuator in its non-operational position. That is, the depth of the recess can be such that the disc brake pad engaging portion is received within the recess when the front side of the pad is engaged against a disc brake rotor (the operational position) as well as when the front side of the pad is disengaged from the disc brake rotor (the non-operational position).

The location of the park brake actuator within the caliper and the consequent location of the recess on the rear side of the brake pad may be selected as desired. In a preferred form, the pad engaging portion of the park brake actuator is arranged to contact a region of the rear side of the disc brake pad which is approximately midway between opposite side edges of the pad, and preferably toward the upper edge of the pad rather than the lower edge. The position selected is preferably such as to optimise the pad pressure distribution across the front side of the pad when it is in contact with the disc brake rotor, however, the position of the recess can be influenced by the position of engagement of the service brake actuator with the rear side of the pad. For example, the pad engaging portion of the park brake actuator may be offset circumferentially or radially from the pad engaging portion of the service brake actuator, which could be located substantially mid-span between opposite side edges of the rear side of the pad, as that is the position which tends to maximise pad life under service brake actuation and to ensure maximum service braking efficiency. In practice, the preferred position of engagement of the service brake actuator with the rear surface of the pad is slightly toward the trailing side edge of the pad, rather than exactly mid-span between the opposite side edges. Thus, the preferred location of the park brake actuator within the caliper and relative to the rear side of the brake pad may be subject to the preferred position of the service brake actuator. Nevertheless, it is to be appreciated that the park brake actuator(s) is preferably located for contact with the rear side of the pad as close to the position disclosed above, i.e. substantially midway between opposite pad side edges and also preferably toward the upper edge of the pad. This is more easily achieved in a caliper which includes a pair of service brake actuators, such that the park brake actuator can be positioned between the pair of service brake actuators to engage the rear side of the pad at the preferred, substantially midway position. In an arrangement with a single service brake actuator, the preferred position of engagement of that actuator with the rear side of the pad, is slightly towards the trailing side edge of the pad from the midway position and in that arrangement, the park brake actuator preferably engages the rear side of the pad on the leading side of the service brake actuator, preferably closely adjacent to the service brake actuator.

In one arrangement, the recess may be provided in a separate plate mounted to the rear side of the disc brake pad. Such an arrangement may potentially provide a means for spreading the load of the pad engaging portion of the park brake actuator over a greater region of the rear side of the pad than is possible in the absence of the separate plate. The provision of a separate plate may, therefore, be particularly useful for high park brake loads. The plate may be mounted to the rear side of the disc brake pad, or any other suitable caliper component, and by any suitable means, including by threaded fasteners.

The present invention has, so far, been described in the context of the rear side of the disc brake pad including a single recess for receiving the pad engaging portion of the park brake actuator. It is to be appreciated, however, that the rear side of the disc brake pad can include two or more recesses. This enables the use of two pad engaging portions for greater clamping load, but more advantageously, it permits a pad of one construction to be used for left and right hand brake assemblies, such as is usually applied to the left and right hand rear wheels of a vehicle. Thus, the pad can include a pair of recesses which are symmetrically positioned on the rear side of the pad and one of the recesses will be engaged in the left hand brake assembly and the other will be engaged in the right hand brake assembly. A pad in which the recess is positioned midway between opposite side edges of the pad can also be used on each of left and right brake assemblies. Thus, the number of different caliper components can be reduced by the use of pads which can be employed in each of left and right brake assemblies. In the arrangement in which the disc brake caliper includes a single service brake actuator and the pad includes two recesses, the recesses are preferably spaced apart generally symmetrically on either side of the location of engagement of the rear side of the pad by the service brake actuator. Preferably the recesses are close to that location of engagement, preferably as close as the construction of the caliper will allow.

Each recess may be provided directly in the rear side of the disc brake pad. This arrangement may be particularly convenient for low park brake loads. Alternatively, each recess may be provided in one or more plates mounted to the rear side of the disc brake pad, or any other suitable caliper component,

The present invention encompasses disc brake calipers having service and park braking capabilities of any practical form and, in particular, may be of the form generally including a hydraulic actuator for service brake actuation and an electric actuator for park brake actuation.

Such an arrangement is broadly described in the specification of the Applicant's pending patent application number WO03/014588 (PCT/AU02/01067), the entire contents of which are incorporated herein by reference. It is to be appreciated, however, that the present invention has broader application than the brake caliper configurations therein disclosed.

Hereinafter, the electric and hydraulic actuators will be described as including actuating means in the form of actuating members. In relation to the hydraulic actuator, the actuating member will be described as a piston, which is disposed within a cylinder. It is to be appreciated, however, that the hydraulic actuator may include actuating means, which is other than a piston.

Further, the hydraulic actuator may include a single piston or a twin piston arrangement. Indeed, further pistons may also be employed such as, for example, in heavy duty vehicle applications.

The electric actuator of a caliper according to the present invention may be of any practical form. As one example, the electric actuator may include an actuating member having means to cooperate with electric drive means spaced from the disc brake pad engaging portion. The actuating member may include an elongated rod and may be arranged for axial movement along its lengthwise axis, preferably by rotational movement about the same axis. In this arrangement, a portion of the outer surface of the rod can be formed with, for example, a male thread. The male thread can mesh with a fixed female mating thread, such as may be formed in the inner wall of a conduit or bore of the caliper housing the rod. Rotation of the rod of the conduit or bore by the electric drive means thus causes the rod to shift axially within the bore by virtue of the threaded meshing engagement. This axial shift can be employed to shift the disc brake pad of the caliper into and out of engagement with the disc brake rotor.

The pad engaging portion of the park brake actuator may be connected to or integrally formed on one end of the elongated rod.

In an alternative arrangement, however, the pad engaging portion of the park brake actuator may be connected to or integrally formed on one end of a connecting member, which preferably is elongated and in general coaxial alignment with the elongated rod. The other end of the connecting member may be in engagement with or connected to one end of the elongated rod, such that axial movement of the elongated rod generates a corresponding axial movement of the connecting member. Thus, the rod and the connecting member can move as one.

The engagement or connection between the elongated rod and connecting member could be of any suitable form. In a particularly preferred form, there may be a universal or ball-and-socket type connection, thereby potentially accommodating any minor misalignment between the pad engaging portion of the park brake actuator and the recess during operation of the park brake actuator. In this arrangement, the rod may include a bore extending from the end thereof which is adjacent the disc brake pad, the bore extending longitudinally along the lengthwise axis of the rod, and the connecting member being disposed at least partially within the bore. The connecting member can be fixed, releasably fixed if preferred, against release from the bore, or it can be non-fixedly positioned within the bore. The bore can be sized so that the connecting member can shift away from coaxial alignment with the rod, preferably by pivoting movement of the connecting member within the bore, to accommodate misalignment. Thus, the bore can be sized to loosely receive the connecting member, allowing movement of the connecting member within the bore.

The connecting member may be generally of a “dog bone” design. A first rounded end of the connecting member may correspond to the pad engaging portion of the park brake actuator, and a second rounded end of the connecting member may be provided for connection within the bore in the end of the elongated rod. In this arrangement, the bore can be formed as a socket arrangement.

The connecting member may also adopt any other suitable configuration. For example, the connecting member may have concavely shaped ends to mate with a convexly (or ball) shaped mount on the rear side of the brake pad and convexly (or ball) shaped end of the elongated rod or inner end of the rod bore. Also, it is possible for the connecting member to have one concavely shaped end and one convexly (or ball) shaped end. Alternatively, one or more of these possible arrangements can be reversed.

### BRIEF DESCRIPTION OF THE DRAWINGS

The attached drawings show example embodiments of the present invention of the foregoing kind. The particularity of those drawings and the associated description does not supersede the generality of the preceding broad description of the invention. These drawings may be better appreciated with reference to the following detailed description, which in turn, refer to these drawings wherein:

FIG. 1 is a side, perspective view of a brake pad according to one embodiment of the present invention;

FIG. 2 is a partially cross-sectional, side, perspective view through A-A of the brake pad illustrated in FIG. 1;

FIG. 3 is a front perspective view of another embodiment of the brake pad of the present invention when incorporated into a brake caliper of the present invention as illustrated in phantom form;

FIG. 4 is a side, elevational, cross-sectional view of another embodiment of the brake pad of the present invention when incorporated into a brake caliper of the present invention;

FIG. 5 is a side, perspective view of a brake pad according to another embodiment of the present invention; and

FIG. 6 is a side, perspective view of a brake pad according to another embodiment of the present invention.

### DETAILED DESCRIPTION

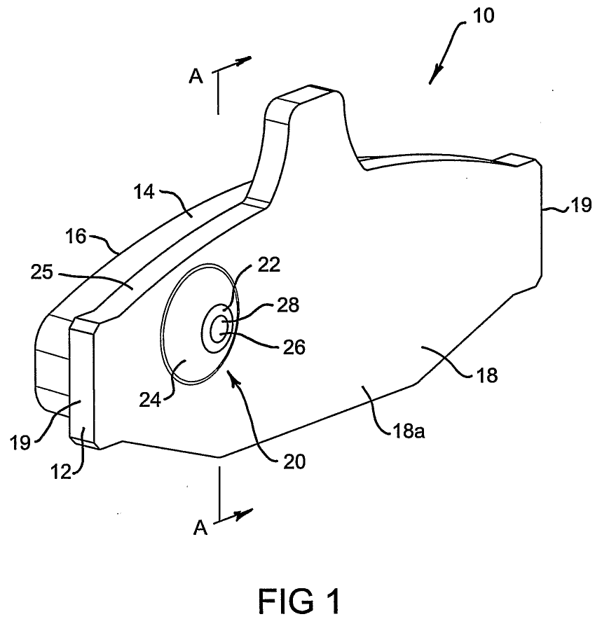

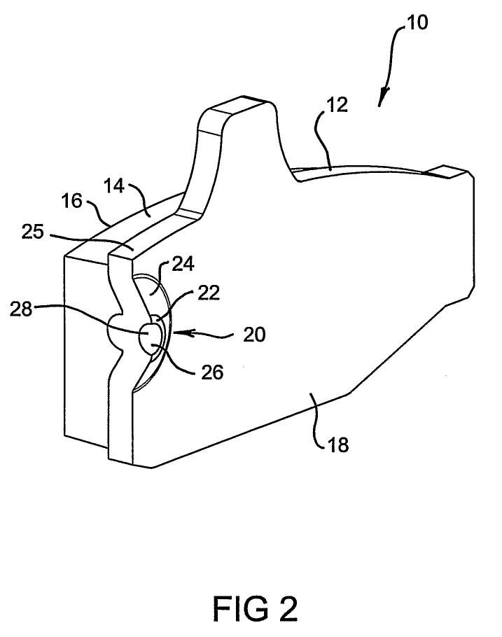

Referring to FIGS. 1 and 2, there is illustrated a disc brake pad 10. The pad 10 includes a supporting member 12 and a friction lining 14 mounted on the supporting member 12. The supporting member 12 and the friction lining 14 may be manufactured from any suitable materials.

The friction lining 14 includes a front side or surface 16 for engaging a disc brake rotor, and the supporting member 12 includes a rear side 18 for contact by respective service and park brake actuators.

The rear side 18 includes a recess arrangement 20. The recess arrangement 20 is generally crater-like (or crateriform). In this respect, the recess arrangement 20 includes a thin planar surface 22, which is raised relative to the planar surface 18a of the rear side 18. It is to be appreciated that the surface 22 may be omitted, if desired. The surface 22 and the surface 18a are separated by curved annular (or alternatively a conical) surface 24.

The recess 26 of the recess arrangement 20 has a concave surface 28 that can be described as generally defining the inner surface of a segment of a sphere. The recess 26 is provided for receiving a complementary-shaped disc brake pad engaging portion of a park brake actuator. The recess 26 is of a sufficient depth to receive the pad engaging portion of the park brake actuator only during operation of the park brake. However, the depth of the recess 26 may be increased so as to receive the pad engaging portion of the park brake actuator both during operation of the park brake, as well as when the parking brake is not in operation. In this respect, the park brake actuator can include a rod that is displaced toward and away from the pad 10 in order to displace the pad 10 in the manner required, into and out of engagement with a disc brake rotor. The rod can include a pad engaging portion at one end of the rod and it is that portion of the rod which can be permanently captured or accommodated within the recess 26 regardless of the position of displacement of the rod. In the alternative, the pad engaging portion can enter the recess during forward travel of the rod to displace the pad 10 into engagement with the rotor, and can be withdrawn from the recess during return movement of the rod when the pad is released from engagement with the rotor.

The location of the recess arrangement 22 on the rear side 18 is dependent on the location within the caliper of the park brake actuator which, in turn is partly dictated by the location of the service brake actuator. Ideally, the recess arrangement 20 is approximately centrally located on the rear side 18 and proximate the pad engagement location of the service brake actuator. This will, in relative terms, maximise the distribution of the load of the park brake actuator over the surface 18a and minimise any undesirable load concentration proximate the surface edge 25. However, in FIG. 1, the recess arrangement 20 is illustrated located toward the surface edge 25, and this indicates that it is acceptable, although not preferred, that the recess arrangement 20 can be positioned away from the central region of the rear side 18 and still perform as required.

Positioning of the recess is somewhat dependent on the position of engagement of the rear side 18 by the service brake actuator. To equalise pad pressure distribution on the disc brake rotor, and to minimise taper wear of the friction lining, engagement of the rear side of the pad preferably occurs approximately midway or mid-span between the opposite side edges 19 of the supporting member 12, and toward the upper or surface edge 25. It is to be noted that the upper or surface edge 25 is an upper edge in relation to the orientation of the pad 10 shown in FIG. 1, but that edge could be oriented differently when fitted in a brake assembly, but it is likely always to be a radially outer edge regardless of its mounting orientation. The service brake actuator is usually arranged to engage the rear side 18 at the optimum position, such that in practice, the service brake actuator engages the rear side 18 of the supporting member 12 slightly toward the trailing edge of the pad 10 from the midway position, with the leading and trailing edges being defined with respect to forward rotation of the disc brake rotor. Thus, the park brake actuator is arranged to engage the rear side 18 away from the optimum position. However the preferred arrangement is to arrange for the park brake actuator to engage the rear side 18 closely adjacent to the position at which the service brake actuator engages the rear side 18.

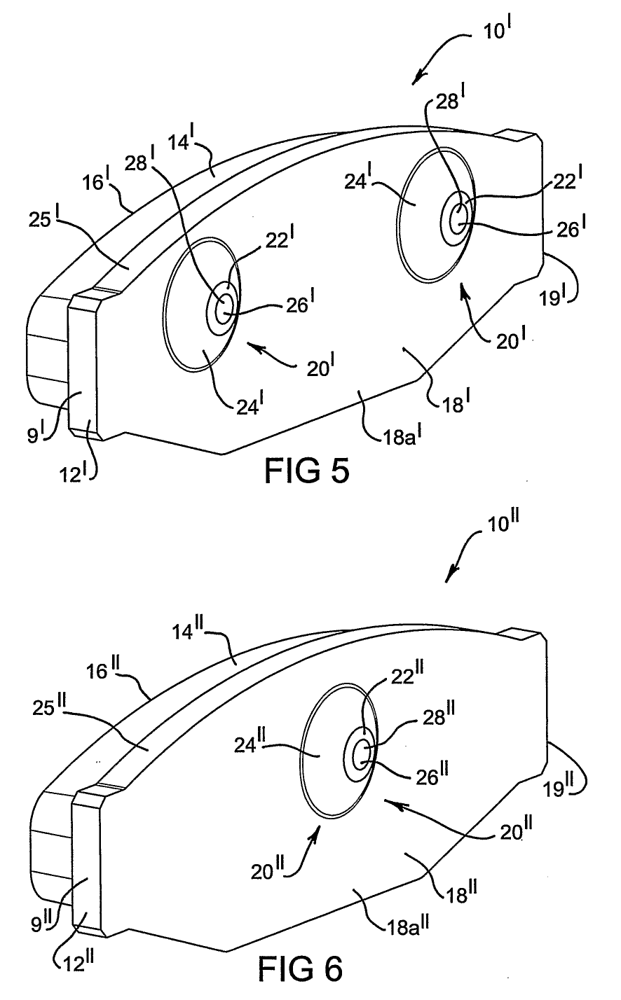

The rear side 18 is illustrated as including a single recess arrangement 20, however, two or more recess arrangements could be included so that the one form of pad could be used for left and right hand brake assemblies. Such a pad could also be employed if the park brake actuator included two or more disc pad engaging portions, or if the caliper included two or more separate park brake actuators each having a pad engaging portion. FIG. 5 illustrates a disc brake pad 10′ having two recess arrangements 20′ and otherwise having features generally the same as the pad 10 of FIG. 1, so that like parts have the same reference numerals plus ′. FIG. 6 illustrates a disc brake pad 10″, having a single recess arrangement 20″ and again otherwise having features which are generally the same as the pad 10 FIG. 1, so that like parts have the same reference numerals plus ″. The FIG. 5 arrangement represents a pad that can receive two park brake pad engaging portions or which can be employed for use in left and right hand brake assemblies. The FIG. 6 arrangement represents a pad which can be employed in an arrangement in which the park brake actuator engages the rear side 18″ of the supporting member 12″ generally midway between the side edges 19″ and toward the surface edge 25″ and the service brake includes two actuators that engage the rear side 18″ on either side of the recess arrangement 20″. The FIG. 6 arrangement also represents a pad which can be employed in left and right hand brake assemblies

The recess arrangement 20 may be incorporated into the supporting member 12 by any suitable manufacturing process, including a bi-directional stamping process.

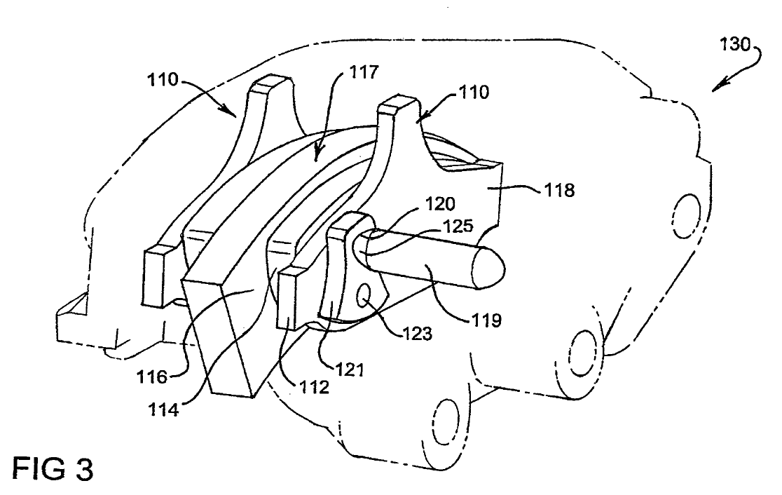

In FIG. 3 there is illustrated a brake caliper 130 including a disc brake pad 110.

The brake pad 110 includes a supporting member 112 and a friction lining 114 mounted on the supporting member 112. The friction lining 114 includes a front side or surface 116 for engaging a disc brake rotor 117, and the supporting member 112 includes a rear side 118 for contact by both a service brake actuator (not illustrated) and a park brake actuator 119.

A plate 121 is mounted on the rear side 118 of the supporting member 112 by a threaded fastener (not illustrated) attached via a mounting aperture 123 provided in the plate 121. The plate 121 includes a recess 120 for receiving a complimentary-shaped disc brake pad engaging portion 125 of the park brake actuator 119. The recess 120 does not extend fully through the thickness of the plate 121. The provision of the plate 121 spreads the operating load of the park brake actuator more evenly over the rear surface 118 of the supporting member 112. This is desirable, as it allows the park brake actuator to operate, in relative terms, under higher park brake loads.

The plate 121 may be of any practical shape.

The plate 121 may include two or more recesses depending on the specific caliper configuration and depending on the number and configuration of park brake actuators. Likewise two or more plates 121 may be incorporated into the caliper configuration, if required. As illustrated, the recess 120 is formed differently to the recess 26 of the disc brake pad 10. The recess 26 is formed as part of a recess arrangement 20, but it is to be appreciated that the arrangements of the disc brake pads 10 and 110 in relation to the recesses could be interchanged.

The disc brake caliper 130 includes a hydraulic actuator (not clearly illustrated) for service brake actuation. The park brake actuator 119 is electrically actuated.

The electric and hydraulic actuators each include actuating means in the form of actuating members. In relation to the hydraulic actuator, the actuating member is in the form of a piston, which is disposed within a cylinder. It is to be appreciated, however, that the hydraulic actuator may include actuating means, which is other than a piston, such as a cam. Further, the hydraulic actuator may include a single piston or a twin piston arrangement. Indeed, further pistons may also be employed, for example, in heavy-duty vehicles.

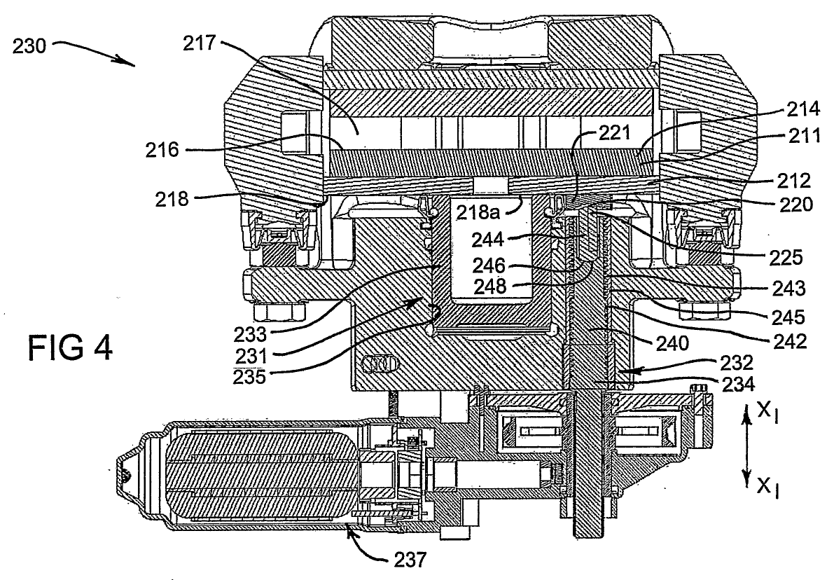

The electric actuator includes an actuating member, the specific configuration of which may be of the form illustrated in FIGS. 4 and 5.

In FIGS. 4 and 5, there is illustrated a brake caliper 230 including a disc brake pad 210. FIG. 4 shows a cross-sectional plan view of the caliper 230, while FIG. 5 is a side view of the same caliper.

The brake pad 210 includes a supporting member 212 and a friction lining 214 mounted on the supporting member 212. The friction lining 214 includes a front surface 216 for engaging a disc brake rotor 217, and the supporting member 212 includes a rear side 218 for contact by both a hydraulic service brake actuator 231 and an electric park brake actuator 232.

A plate 221 is mounted on the rear surface 218a of the supporting member 212. The plate 221 includes a recess 220 for receiving a complementary-shaped disc brake pad engaging portion 225 of the park brake actuator 219. The provision of the plate 221 spreads the operating load of the park brake actuator more evenly over the rear surface 218a of the supporting member 212. This is desirable, as it allows the park brake actuator to operate, in relative terms, under higher park brake loads.

The electric and hydraulic actuators 231,232 each include actuating means in the form of actuating members. In relation to the hydraulic actuator 231, the actuating member is in the form of a piston 233, which is disposed within a cylinder 235. It is to be appreciated, however, that the hydraulic actuator 231 may include actuating means, which is other than a piston. Further, the hydraulic actuator 231 may include a single piston or a twin piston arrangement. Indeed, further pistons, say third and fourth pistons, may also be employed, for example, in heavy-duty vehicles.

The electric actuator 232 includes an actuating member 234 which cooperates with electric drive means 237. The actuating member 234 includes an elongated rod 240 arranged for axial movement in the direction X1-X1 along its lengthwise axis, by rotational movement about the same axis. For this, a portion of the outer surface of the rod 240 includes a male thread 242, which meshes with a fixed female mating thread 243 formed on the inner wall of a conduit or bore 245. Rotation of the rod 240 by the electric drive means 237 about its lengthwise axis causes it to shift axially within the bore 245 by virtue of the threaded meshing engagement. That axial shift can be employed to shift the disc brake pad 210 of the caliper 230 at least into, and in some constructions out of, engagement with the disc brake rotor 217.

The pad engaging portion 225 of the park brake actuator 219 is integrally formed as a convexly shaped end on an elongated member 244. The member 244 is separately fitted to the rod 240 within a bore 248 and is in general coaxial alignment with the rod 240. For reasons which will be explained hereinafter, the member 244 can be a loose fit within the bore 248. The end 246 of the connecting member 244 is convex and seats against an inner end of the bore 248 of the elongated rod 240 which inner end has a complementary concave shape. Axial movement of the elongated rod 240 within the bore 245 generates a corresponding axial movement of the connecting member 244.

The mating relationship between the convexly shaped end 246 of the connecting member 244 and the concavely shaped inner end of the bore 248 allows for accommodation of any minor misalignment, lateral deflection or displacement between the disc brake pad engaging portion 225 of the park brake actuator and the recess 220 during operation of the park brake actuator 219, by slight movement of the member 244 within the bore 248.

Advantageously, the provision of recesses 26,120,220 can accurately locate the pad engaging portion of the park brake actuator relative to the rear side of the pad and thus the recesses can minimise relative movement between the pad engaging portion and the rear side of the pad during park brake operation. Also, the provision of recesses 26,120,220 provides a more robust interaction between the pad engaging portion of the park brake actuator and the rear side of the pad than is possible in the absence of such a recess or recesses.

The provision of recesses 26,120,220 may also be configured to capture the pad engaging portion of the park brake actuator even when the park brake is not in use. This may advantageously minimise any possibility of alignment problems occurring between the recess 26,120,220 and the pad engaging portion of the park brake actuator during park brake operation.

Thus the present invention can provide more precise and efficient operation of the ark brake actuator.

The invention described herein is susceptible to variations, modifications and/or additions other than those specifically described and it is to be understood that the invention includes all such variations, modifications and/or additions which fall within the spirit and scope of the above invention.

1. A disc brake pad, comprising a front side for engaging a disc brake rotor and a rear side for engagement by respective service and park brake actuators, the rear side of the pad comprising a recess for receiving a disc brake pad engaging portion of the park brake actuator.

2. A disc brake pad according to claim 1, wherein the recess has a size and shape which is substantially complementary to the disc brake pad engaging portion of the park brake actuator.

3. A disc brake pad according to claim 1, wherein the rear side of the disc brake rotor has a rear surface which is generally planar and the recess extends inwardly from the rear surface toward the front side of the disc brake pad.

4. A disc brake pad according to claim 1, wherein the rear side of the disc brake rotor has a rear surface which is generally planar and the recess is formed in a recess arrangement which is generally crater-like and includes a rim which raised away from the rear surface, said recess extending inwardly from the rim.

5. A disc brake pad according to claim 1, wherein the depth of the recess is such that the disc brake pad engaging portion can be received within the recess when the front side of the disc brake pad is engaged against a disc brake rotor as well as when the front side of the disc brake pad is disengaged from the disc brake rotor.

6. A disc brake pad according to claim 1, wherein the disc brake pad includes opposite side edges and the recess is located substantially between the opposite side edges of the rear side of the disc brake pad.

7. A disc brake pad according to claim 1, wherein the recess is located offset circumferentially and/or radially from a portion of the pad which is engaged by the service brake actuator.

8. A disc brake pad according to claim 7, wherein the rear side of the pad is engaged in use by the park brake actuator at a location which is adjacent to the location of engagement of the service brake actuator.

9. A disc brake pad according to claim 8, wherein the rear side of the pad is engaged in use by the service brake actuator at a location which is substantially midway between opposite side edges of the rear side of the disc brake pad.

10. A disc brake pad according to claim 1, wherein the rear side of the disc brake pad comprises a plate which is mounted to a surface of the rear side of the disc brake pad and the plate comprises the recess.

11. A disc brake pad according to claim 10, wherein the plate is operable to spread load imparted to it by the pad engaging portion of the park brake actuator over an area of the surface of the rear side of the disc brake pad on which the plate is mounted.

12. A disc brake pad according to claim 1, wherein the rear side of the disc brake pad comprises a second recess.

13. A disc brake pad according to claim 12, wherein the first and second recesses are spaced apart generally symmetrically on either side of the location of engagement of the rear side of the disc brake pad by the service brake actuator.

14. A disc brake caliper comprising a service brake actuator, a park brake actuator, a disc brake rotor, and disc brake pads which in use are supported by the disc brake caliper on either side of the disc brake rotor, at least a first of the disc brake pads being a pad according to claim 1, each of the service brake actuator and the park brake actuator being arranged for engagement with the rear side of the at least a first disc brake pad and being operable to shift the at least a first disc brake pad into engagement with the disc brake rotor, the park brake actuator comprising a disc brake pad engaging portion for receipt within the recess of the at least a first disc brake pad at least when the park brake actuator is operating to shift the at least a first disc brake pad into engagement with the disc brake rotor.

15. A disc brake caliper comprising a service brake actuator, a parking brake actuator, a disc brake rotor, and disc brake pads which in use are supported by the disc brake caliper on either side of the disc brake rotor, each of the disc brake pads comprising a front side for engaging a side of the disc brake rotor, and a rear side, each of the service brake actuator and the park brake actuator being arranged for engagement with the rear side of a first of the disc brake pads and wherein the park brake actuator comprises a disc brake pad engaging portion and the a first of the disc brake pads comprises a recess for receiving the disc brake pad engaging portion at least when the park brake actuator is operating to shift the a first of the disc brake pads into engagement with the disc brake rotor.

16. A disc brake caliper according to claim 15, wherein the a first of the disc brake pads includes opposite side edges, and the service brake actuator engages the rear side of the a first of the disc brake pads substantially midway between the opposite side edges of the rear side of the a first of the disc brake sides and the park brake actuator engages the rear side of the a first of the disc brake pads adjacent the position of engagement of the service brake actuator.

17. A disc brake caliper according to claim 15, and comprising two parking brake actuators and wherein the a first of the disc brake pads comprises two recesses for receiving a respective disc brake pad engaging portion of each of said park brake actuators.

18. A disc brake caliper according to claim 17, wherein said two recesses of the a first of the disc brake pads are positioned symmetrically on either side of the position of engagement of the service brake actuator with the rear side of the a first of the disc brake pads.

19. A disc brake caliper according to claim 15, wherein the park brake actuator comprises an elongated rod which is arranged for axial movement along its lengthwise axis.

20. A disc brake caliper according to claim 18, wherein an outer surface of the elongated rod is threaded and mates with the threaded surface of a bore, and whereby axial movement of the elongated rod is generated by relative rotation between the elongated rod and the bore.

21. A disc brake caliper according to claim 19, wherein the elongated rod comprises a member which is fitted to the elongated rod and which comprises the disc brake pad engaging portion.

22. A disc brake caliper according to claim 21, wherein the elongated rod comprises a bore formed in one end thereof which is coaxial with the lengthwise axis of the elongated rod, the member being loosely fitted within the bore so that the member can shift transversely relative to the axis of the bore.

23. A disc brake caliper according to claim 22, wherein opposite ends of the member are concave or convex shaped, and engage against complementary shaped surfaces of the recess and the bore.
